(19) United States
(12) Patent Application Publication
(10) Pub. No.: US 2023/0235616 A1
(43) Pub. Date: Jul. 27, 2023

(54) VIBRATION ISOLATOR FOR OVERHEAD DOORS

(71) Applicant: CornellCookson, LLC, Mountain Top, PA (US)

(72) Inventor: Christopher John Rebarchak, White Haven, PA (US)

(21) Appl. No.: 17/582,564

(22) Filed: Jan. 24, 2022

(51) Int. Cl. E06B 3/44; E05D 15/22; F16F 15/08

(52) U.S. Cl. CPC E06B 3/44; E05D 15/22; F16F 15/08; E06B 2003/7044

(57) ABSTRACT

In an example an overhead door track is provided. The overhead door track includes a vertical track section having an opening to receive a roller of a panel of an overhead door and to guide movement of the roller within the opening and a single solid polymer based vibration isolator coupled to the vertical track section to reduce vibration of the vertical track section caused by movement of the roller within the opening.

### BACKGROUND

Overhead doors can be used to control access into buildings. Typically, such an overhead door has a number of rectangular door panels or panel sections, the total area of which is similar or equal to the area of the aperture that needs to be closed, and the width of which is close to the width of the wall opening that needs to be closed.

In some embodiments, the panel sections are joined to each other at their longitudinal edges with hinges. In other embodiments, the panels can be unconnected from each other and moved as separated panels. The overhead door moves on two lateral tracks by means of rollers.

The tracks have three sections: vertical, transitional, and horizontal sections. When the overhead door is vertical in a closed position, the wall opening is covered by the overhead sectional door. When the overhead door is opening, the panels move up, pass the track transitional section, and move into the track horizontal section of the track to rest in a horizontal position or “open” position. When the overhead door is in the horizontal position, the door is situated superjacent to the wall opening.

### BRIEF DESCRIPTION OF THE DRAWINGS

The teaching of the present disclosure can be readily understood by considering the following detailed description in conjunction with the accompanying drawings, in which:

FIG. 1 illustrates an example overhead door with connected panels of the present disclosure viewed from the inside of a building;

FIG. 2 illustrates an example overhead door with separated panels of the present disclosure viewed from the inside of a building;

FIG. 3 illustrates an isometric view of an example of a vibration isolator of the present disclosure;

FIG. 4 illustrates a front view of an example of a vibration isolator of the present disclosure coupled between a doorway structure and a track of the overhead door;

FIG. 5 illustrates a side view an example of the vibration isolator coupled between the doorway structure and the track of the overhead door;

FIG. 6 illustrates a side view of an example of a vibration isolator of the present disclosure pre-attached to a track of the overhead door;

FIG. 7 illustrates a close up view of the track before being assembled to the vibration isolator; and

FIG. 8 illustrates a close up view of the track being assembled to the vibration isolator.

To facilitate understanding, identical reference numerals have been used, where possible, to designate identical elements that are common to the figures.

### DETAILED DESCRIPTION

The present disclosure relates to a vibration isolator for overhead doors. As discussed above, an overhead door has a number of rectangular door panels or panel sections. The overhead door moves on two lateral tracks by means of rollers. The tracks have three sections: vertical, transitional, and horizontal sections.

Movement of the panels within the tracks can cause vibrations. The vibrations can create relatively loud operation of the overhead door when the door is opened and closed. The vibrations can also cause the tracks or guides to slightly move over time. The movement can cause functional issues with the door over time. For example, the rollers of the panels can be slightly misaligned with the guides that have moved. This can lead to even larger vibrations causing further movement, louder operational noise, or cause the overhead door to become stuck during operation.

The present disclosure provides a vibration isolator or dampener for overhead doors. The vibration isolator may be formed from a single solid piece of a polymer. The vibration isolator may be based on a family of nitrile rubber. The vibration isolator may help to reduce vibrations caused by operation of the overhead door, provide long term stability and prevent shifting of the guides after multiple cycles of opening and closing the overhead door, and maintain R-values for the overhead door.

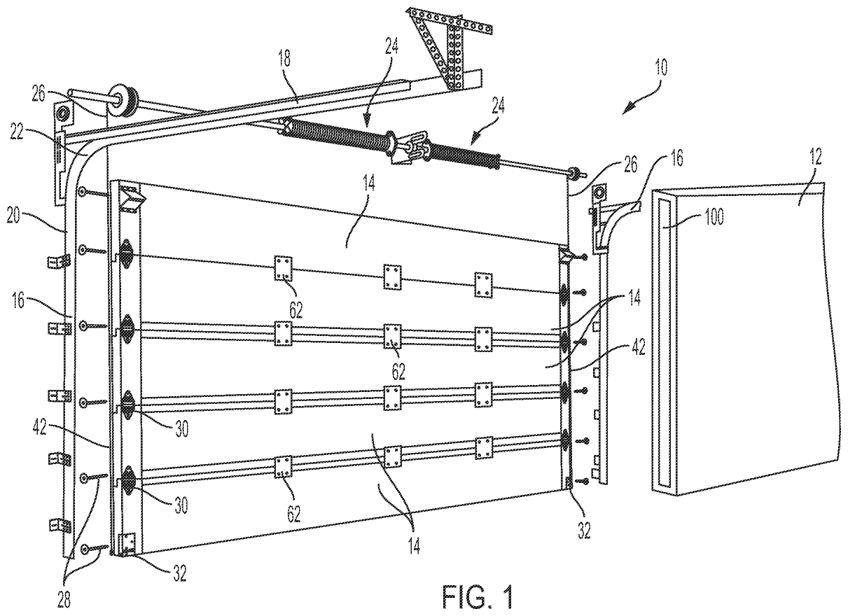

FIG. 1 illustrates an example overhead door 10 with connected panels 14 that include a vibration isolator or dampener 100 of the present disclosure. The example overhead door 10 may be a rolling door that is utilized in a residential, commercial, institutional, or other structure to selectively cover an opening in a wall of the structure.

As shown in FIG. 1, the overhead door 10 includes a number of elongate and generally horizontally oriented door panels 14 (also referred to herein as panels 14). The overhead door 10 and the panels 14 are movable selectively to and between a closed position in which the door covers an opening in a doorway structure 12 and an open position which exposes the opening in the doorway structure 12 and positions the panels 14 in a head area superjacent to the opening in the doorway structure 12.

As can be further seen in FIG. 1, the panels 14 are each mounted within a track system or overhead door track 16 on the left and right sides of the opening in the doorway structure 12. It should be noted that FIG. 1 illustrates one side of the doorway structure 12. The opposite side of the doorway structure 12 is not shown. In addition, FIG. 1 illustrates an exploded view of the overhead door 10, the track system 16, and the doorway structure 12 to show the vibration isolator 100 and other various components.

In one embodiment, the track system 16 may include a horizontal track section 18, a vertical track section 20, and a transition track section 22 mounted on each side of the opening in the doorway structure 12. The track system 16 may be located at lateral ends 42 of the panels 14.

In one embodiment, the panels 14 may be interconnected with hinges 62. The hinges 62 may keep adjacent panels 14 connected as the panels 14 move to an open position. The hinges 62 bend or rotate as the panels 14 move through the transition track section 22 of the track system 16.

Each panel 14 may include a roller hinge 30 that is connected at the lateral ends 42 of the panel 14. The roller hinge 30 may include a roller 28 for coupling the overhead door 10 to the track system 16. The track system 16 may have a generally J-shaped cross-sectional configuration into which each roller 28 is captured to assist in the movement and articulation of the overhead door 10 to and between the closed and open positions as the rollers 28 translate along the vertical track section 20, the transition track section 22, and the horizontal track section 18 of the track system 16.

The panels 14 are raised and lowered to open and close the opening for traffic to pass through, as required. The weight of the panels 14 is counterbalanced by a set of extension springs or a counterbalance system 24, which is in turn indirectly fastened to a cable 26, which is directly fastened to either the upper panel or a bottom bracket 32 on a lower panel. The overhead door 10 may be between 6 feet to 15 feet in width and 3 feet to 12 feet in height.

In one embodiment, as a torsion rod of the counterbalance system 24 rotates as the overhead door 10 opens or closes, a drum at each end of the torsion rod also rotates. The cable 26, having a first end secured to one of the drums and a second end secured to one of the bottom brackets 32, may be wound on the drum when the overhead door 10 opens, helping to lift the overhead door 10, and may unwind from the drum when overhead door 10 closes, controlling the descent of the overhead door 10.

In one embodiment, the counterbalance system 24 may include extension springs located to the mounting brackets of the track system 16 with a cable 26 that is attached to the bottom bracket 32. One end of an extension spring may be secured to a ceiling-mounted bracket. A second end of the extension spring may be secured to a first pulley. The cable 26 may extend around the first pulley, over a stationary pulley, and to the bottom bracket 32.

The vibration isolator or dampener 100 may help reduce, absorb, or dampen vibrations in the overhead door 10 as the overhead door is opened and closed, as described above. The vibration isolator 100 may also prevent the vertical track portion 20 from shifting or moving over time.

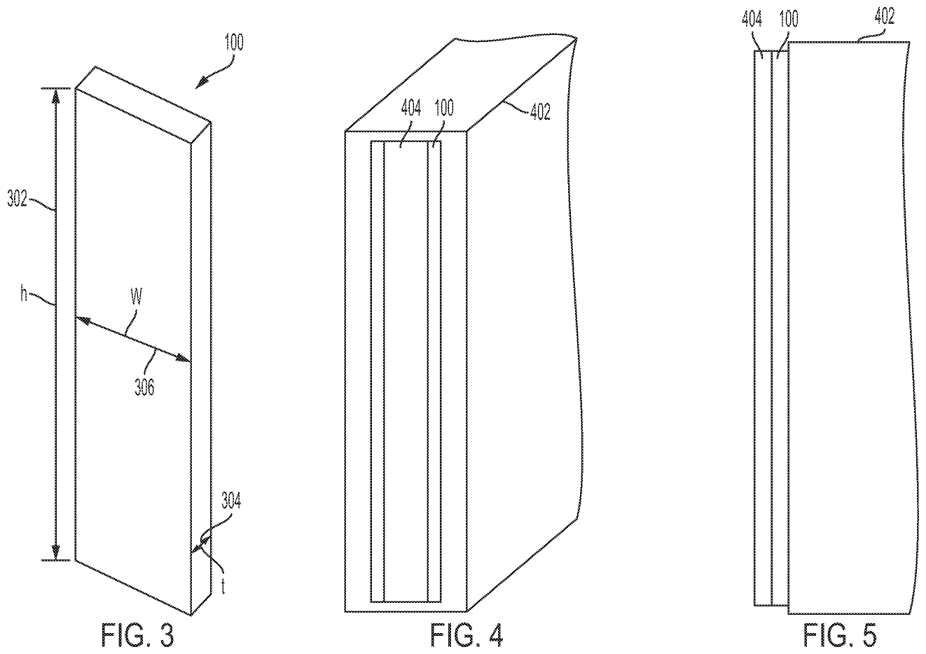

In addition, the vibration isolator 100 may help maintain an R-value for the overhead door 10. R-value may be a measure of how well a two-dimensional barrier (e.g., the overhead door 10) resists conductive flow of heat. The R-value may be defined as a temperature difference per unit of heat flux needed to sustain one unit of heat flux between the warmer surface (e.g., the interior side of the overhead door 10) and the colder surface (e.g., the exterior side of the overhead door 10 exposed to the outdoor environment) of a barrier under steady-state conditions. Further details of the vibration isolator 100 are illustrated in FIGS. 3-6 and discussed below.

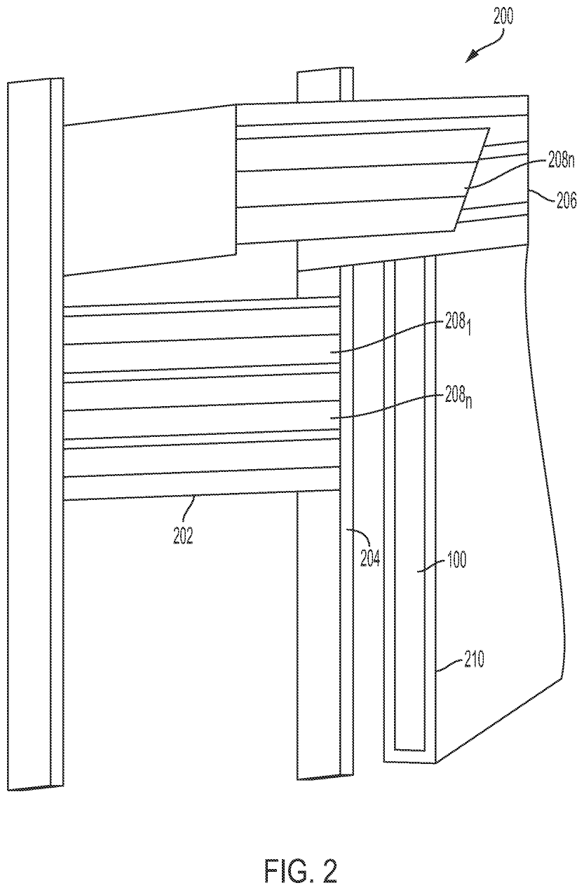

FIG. 2 illustrates an example overhead door system 200 with separated panels 208₁ to 208ₙ that includes the vibration isolator 100 of the present disclosure. The overhead door system 200 may include a door 202 that is comprised of a plurality of panels 208₁ to 208ₙ (hereinafter also referred to individually as a panel 208 or collectively as panels 208). The door 202 may be opened by moving the panels 208 vertically along a vertical track portion 204. As the panels 208 are separated, the panels 208 can be stacked along a horizontal track portion 206.

In one embodiment, the panels 208 may include end caps that include wheels or rollers (e.g., similar to the rollers 28 illustrated in FIG. 1) that can move within vertical track portion 204 and the horizontal track portion 206. The horizontal track portion 206 may be positioned at a slight angle to allow for gravity assist when the door 202 is closing.

In one embodiment, the door 202 may be closed by moving the panels 208 towards the vertical track portion 204 one-by-one. The panels 208 may be stacked on top of one another as the door 202 is closed.

In one embodiment, the vertical track portion 204 may be coupled to an opening of a doorway structure 210. For example, a first vertical track portion 204 may be coupled to a first side of the doorway structure 210 and a second vertical track portion 204 may be coupled to a second side of the doorway structure 210 opposite the first side. In one embodiment, the vibration isolator 100 may be located between the vertical track portion 204 and a surface of the doorway structure 210 on both sides of the doorway structure.

As noted above, the vibration isolator or dampener 100 may help reduce, absorb, or dampen vibrations in the overhead door 10 as the overhead door is opened and closed, as described above. The vibration isolator 100 may also prevent the vertical track portion 20 from shifting or moving over time. The vibration isolator 100 may help maintain an R-value for the overhead door 10. Thus, as illustrated in FIGS. 1 and 2, the vibration isolator 100 may be used in a variety of different types of overhead doors 10 and 200 that use vertical track portions 20 or 204, respectively.

FIG. 3 illustrates an isometric view of an example of the vibration isolator 100 of the present disclosure. The vibration isolator 100 may have a height (h) measured along a line 302, a thickness (t) measured along a line 304, and a width (w) measured along a line 306. The height 302 and the width 306 of the vibration isolator 100 may be equal to or larger than a height and a width of the track 16 or 204.

In one embodiment, the vibration isolator 100 may have a thickness 304 that prevents movement of the track 16 or the track 204 over time as the overhead door is opened and closed. As noted above, having a thickness 304 that is too large may cause functional issues with the overhead door over time.

In one embodiment, the vibration isolator 100 may have a thickness between 3/16 inches to ⅜ inches. In one embodiment, the vibration isolator 100 may have a thickness of approximately ⅜ inches.

In one embodiment, the vibration isolator 100 may be fabricated as a single solid polymer based material. For example, the polymer based material may be a nitrile based polymer. In one embodiment, the vibration isolator 100 may be fabricated as a single solid nitrile rubber based material. In one embodiment, the nitrile based polymer or the nitrile rubber may be nitrile butadiene. In another example, the single solid polymer based material may include neoprene rubber.

In one embodiment, the vibration isolator 100 may have a shore hardness (A) of between 20A to 60A. Shore hardness may be a measure of a material's resistance to indentation. Shore hardness may provide a scale of hardness for different materials, including rubber and plastics. In one embodiment, the shore hardness of the vibration isolator 100 may be 20A, 40A,

FIG. 4 illustrates a block diagram of an example of the vibration isolator 100 located between a track 404 and a doorway structure 402. The track 404 may be similar to the track 16 illustrated in FIG. 1 or the track 204 illustrated in FIG. 2. FIG. 4 illustrates how the track 404 is coupled to vibration isolator 100 and against the doorway structure 402. Also, as noted above, the vibration isolator 100 may have a height 302 and a width 306 that is equal to or greater than the height and the width of the track 404.

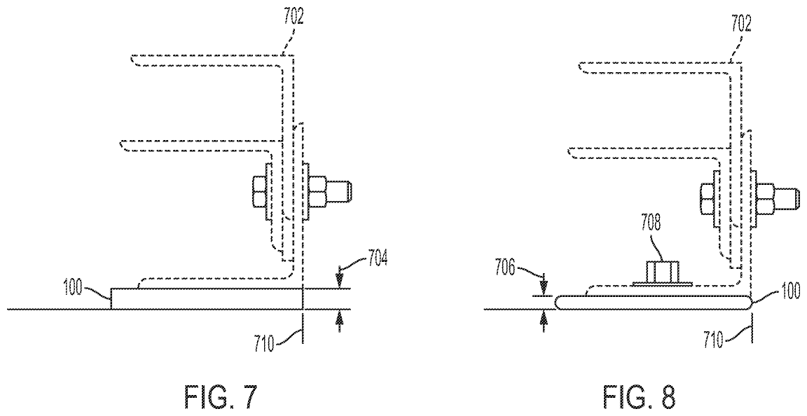

FIG. 5 illustrates a block diagram of a side view of the vibration isolator 100 located between the track 404 and the doorway structure 402. As will be discussed in further details below and shown in FIGS. 7 and 8, the thickness 304 of the vibration isolator 100 may be compressed when installed between the track 404 and the doorway structure 402.

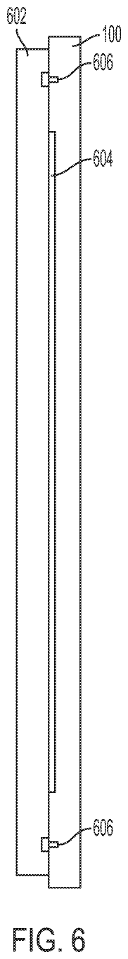

FIG. 6 illustrates a side view of a track 602 and the vibration isolator 100. The track 602 may be similar to the track 16 illustrated in FIG. 1 or the track 204 illustrated in FIG. 2.

FIG. 6 illustrates an example where the vibration isolator 100 may be pre-coupled to the track 602. As a result, the track 602 and the vibration isolator 100 do not have to be installed separately. Rather, a technician may simply install the track 604 with the vibration isolator 100 pre-attached to a doorway structure in a single step.

In one embodiment, the vibration isolator 100 may be coupled to the track 602 via a mechanical coupling 606, an adhesive 604, or a combination of both. In one example, the adhesive 604 may be a glue or a double sided tape. The adhesive 604 may be applied along a height of the vibration isolator 100 and the track 602. In one embodiment, the mechanical coupling 606 may be a screw, a nut and bolt, or any other type of fastener.

FIGS. 7 and 8 illustrate a close up view of a portion of a track 702 that is coupled to the vibration isolator 100. The track 702 may be similar to the track 16 illustrated in FIG. 1 or the track 204 illustrated in FIG. 2.

FIG. 7 illustrates the vibration isolator 100 with an initial thickness 704 before the track 702 is coupled against the vibration isolator 100. The vibration isolator 100 may be placed against a doorway structure 710.

FIG. 8 illustrates the vibration isolator 100 with a compressed thickness 706 after the track 702 is coupled against the vibration isolator 100 and the doorway structure 710. The track 702 may be coupled to the vibration isolator 100 and the doorway structure 710 with a mechanical fastener 708 (e.g., a bolt, a screw, and the like).

As can be seen in FIG. 8, the vibration isolator 100 may be compressed when installed against the track 702 and the doorway structure 710. The compressed thickness 706 may be less than the initial thickness 704. The compression of the vibration isolator 100 may help to reduce vibrations in the door and track 702 when the door is opened and closed. The compression may also help maintain and R-value of the entire overhead door assembly/system, as noted above.

Thus, the present disclosure provides a vibration isolator that is made of a particular type of material with specific characteristics and dimensions to work with an overhead door. The vibration isolator may be designed to reduce vibrations caused by operation of the overhead door, provide long term stability and prevent shifting of the guides after multiple cycles of opening and closing the overhead door, and maintain R-values for the overhead door.

It will be appreciated that variants of the above-disclosed and other features and functions, or alternatives thereof, may be combined into many other different systems or applications. Various presently unforeseen or unanticipated alternatives, modifications, variations, or improvements therein may be subsequently made by those skilled in the art which are also intended to be encompassed by the following claims.

1. An overhead door track, comprising:
a vertical track section having an opening to receive a roller of a panel of an overhead door and to guide movement of the roller within the opening; and
a single solid polymer based vibration isolator coupled to the vertical track section and a doorway structure to reduce vibration of the vertical track section caused by movement of the roller within the opening, wherein the single solid polymer based vibration isolator has a thickness between 3/16 inches to ⅜ inches.

2. The overhead door track of claim 1, wherein the single solid polymer based vibration isolator comprises a nitrile based polymer.

3. The overhead door track of claim 2, wherein the nitrile based polymer comprises nitrile butadiene.

4. (canceled)

5. The overhead door track of claim 1, wherein the single solid polymer based vibration isolator has a shore hardness (A) of between 20A to 60A.

6. The overhead door track of claim 1, wherein the single solid polymer based vibration isolator has a width and a length that are equal to or greater than a width and a length, respectively, of the vertical track section.

7. The overhead door track of claim 1, wherein the single solid polymer based vibration isolator is coupled to the vertical track section via an adhesive.

8. The overhead door track of claim 1, wherein the single solid polymer based vibration isolator is coupled to the vertical track section via a mechanical fastener.

9. The overhead door track of claim 1, wherein the single solid polymer based vibration isolator is coupled to the vertical track section before the vertical track section is coupled to the doorway structure.

10. An overhead door track, comprising:
a vertical track section having an opening to receive a roller of a panel of an overhead door and to guide movement of the roller within the opening; and
a single solid nitrile rubber based vibration isolator coupled to the vertical track section and to a doorway structure to reduce vibration of the vertical track section caused by movement of the roller within the opening, wherein the single solid nitrile rubber based vibration isolator has a thickness between 3/16 inches to ⅜ inches.

11. The overhead door track of claim 10, wherein the single solid nitrile rubber based vibration isolator comprises nitrile butadiene.

12. (canceled)

13. The overhead door track of claim 10, wherein the single solid nitrile rubber based vibration isolator has a shore hardness (A) of between 20A to 60A.

14. The overhead door track of claim 10, wherein the single solid nitrile rubber based vibration isolator has a width and a length that is equal to or greater than a width and a length, respectively, of the vertical track section.

15. An overhead door, comprising:
a track system, comprising a vertical track section, a transition track section, and a horizontal track section, wherein the vertical track section comprises a first vertical track section and a second vertical track section that are coupled to opposite sides of a doorway structure;
a plurality of panels, wherein each panel of the plurality of panels comprises rollers on opposite sides of the each panel, wherein the rollers are captured by the track system to guide movement of the plurality of panels; and
a solid nitrile rubber based vibration dampener, wherein the solid nitrile rubber based vibration dampener is located between the first vertical track section and a first side of the doorway structure and between the second vertical track section and a second side of the doorway structure, wherein the solid nitrile rubber based vibration dampener has a thickness between 3/16 inches to ⅜ inches.

16. The overhead door of claim 15, wherein the solid nitrile rubber based vibration dampener comprises nitrile butadiene.

17. (canceled)

18. The overhead door of claim 15, wherein the solid nitrile rubber based vibration dampener has a shore hardness (A) of between 20A to 60A.

19. The overhead door of claim 15, wherein panels of the plurality of panels are interconnected.

20. The overhead door of claim 15, wherein the panels of the plurality of panels are separated.
